(19) United States
(12) Patent Application Publication
(10) Pub. No.: US 2003/0200157 A1
(43) Pub. Date: Oct. 23, 2003

(54) Point of sale selection system

(76) Inventor: Russell S. Krajec, Berthoud, CO (US)

Correspondence Address: THE LAW OFFICES OF WILLIAM W. COCHRAN, LLC, 3555 STANFORD ROAD, SUITE 230, FORT COLLINS, CO, 80525, US

(21) Appl. No.: 10/175,226

(22) Filed: Jun. 17, 2002

Related U.S. Application Data
(60) Provisional application No. 60/374,892, filed on Apr. 22, 2002.

(51) Int. Cl. G06F 17/60; G06F 7/00

(52) U.S. Cl. 705/28

(57) ABSTRACT

Disclosed are a device and method for searching and displaying of movie titles, as an aid to helping a customer of a video rental store find an appropriate movie title to rent. A kiosk may be located in the video rental store and available for a customer to search and preview movies. The kiosk may reference the customer's history of rented movies, a database of comparable movies, a database of popular movies, a database of the current inventory of the store, and other factors for providing a search result and other movies that may be of interest to the consumer. The use of the inventory of the current store in a search allows a retailer to offer promotions and special packages instantly while maximizing sales.

### CROSS REFERENCE TO RELATED APPLICATIONS

This application claims the benefit of U.S. Provisional Patent Application 60/374,892 entitled “Point of Sale Selection System” by Russell S. Krajec filed Apr. 22, 2002, the entire content of which is hereby incorporated by reference for all it discloses and teaches.

### BACKGROUND OF THE INVENTION

a. Field of the Invention

The present invention pertains generally to consumer recommendation systems used to aid purchases and specifically to recommendation systems that use a point of sale interface with a link to the store inventory.

b. Description of the Background

Video rental stores often have a wide variety of movies spanning many genres. For the casual movie fan, selecting a movie may be a daunting task, given the wide variety of movies. Many selections are made based on reading the jackets of the movies arrayed on a shelf, which the renter must browse to find a movie to enjoy. For those people wishing to see a movie similar to one they had already viewed, a recommendation from a friend or store clerk may have to suffice.

In some cases, the renter may wish to view a movie trailer prior to renting it. A description of the movie plot, actor's and director's names, plus other criteria may be helpful in locating and selecting a movie.

Similarly, customers in bookstores and music stores have need to search and preview a selection of books or music titles to assist in finding the right book or music CD or other media.

The customer may wish to have some information relating to the immediate availability of the various recommendations. For a computer recommendation system to suggest titles that are not available would be disheartening to the customer.

The retailer has various titles that may not rent very often. The slower moving titles represent inventory for which little revenue is generated. Customers expect that a large video store have a correspondingly large inventory, however, most of the store revenue is generated by the newest releases. The film makers advertise and promote only movies as they are released, but not after they have been sitting on the shelves of the video store for an extended period of time. The older movies are relegated to a discount section of the store and the retailer has very few options to promote these titles.

It would therefore be advantageous to provide a device and method of browsing and selecting a movie while in a video rental store. The device and method may allow a movie to be previewed and provide recommendations and searching based on several criteria. It would be further advantageous for a recommendation system to incorporate references to the current available inventory, and especially to promote titles that otherwise would receive little or no advertising.

### SUMMARY OF THE INVENTION

The present invention overcomes the disadvantages and limitations of the prior art by providing a device and method for selecting and optionally previewing a movie using several criteria. The device comprises a kiosk that may comprise a touch screen user interface and an optional card reader for personal identification of the user. The kiosk may have several different methods for presenting recommendations, searching, and browsing. The recommendation system may refine the recommendations based on the inventory of the store. Such inventory related recommendations may be selected to promote certain titles that have not been selling well, or the recommendations may be to not promote certain titles that are hot sellers.

Within this specification, reference is made to an exemplary system as designed for a video rental store. Those skilled in the art will appreciate that the present invention may be applied to other retail venues, such as bookstores, music stores, computer game stores, or other stores where various media are sold at retail.

The present invention may therefore comprise a system for assisting a purchaser in the selection of a product comprising: a kiosk, the kiosk comprising a display and at least one input device, the kiosk being located in a retail store; a server computer; the server computer being in communication with the kiosk; a first database, the first database comprising recommendation data about products to be sold at the store; a second database, the second database comprising inventory data about current inventory of products available at the store; a software system, the software system being adapted to receive a query from the purchaser, retrieving recommendation data from the first database, retrieving inventory data from the second database, and presenting at least a portion of the recommendation data and the inventory data on the display.

The present invention may further comprise a method of assisting a customer at a point of sale location comprising: providing a graphical interface at a location within a retail store such that the customer may enter a query; transmitting the query to a server computer; receiving the query at the server computer; comparing the query to a recommendation database and retrieving recommendation results; comparing the query to an inventory database and retrieving inventory results; generating a query result based at least partially on the recommendation results and the inventory results; transmitting the query result to the kiosk; receiving the query result by the kiosk; and displaying the query result on the kiosk to assist the customer.

The advantages of the present invention are that a consumer may search and preview movies at the store and within arm's reach of the movie to take home and view. The kiosk may access the customer's personal history of rented movies to form a basis for recommending alternative movies that are similar to those the customer has rented before. The kiosk may access a current inventory of the store to display available movies, and the kiosk may make certain movies available at special discounts.

### BRIEF DESCRIPTION OF THE DRAWINGS

In the drawings,

FIG. 1 is an illustration of an embodiment of the present invention of a video store kiosk.

FIG. 2 is an illustration of an embodiment of the present invention of the internal components of a kiosk.

FIG. 3 is an illustration of an embodiment of the present invention showing the network connections of several kiosks to a server that is optionally connected to the internet.

FIG. 4 is an illustration of an embodiment of the present invention showing the network connections between two stores.

FIG. 5 is an illustration of a work flow diagram of an embodiment of the present invention wherein recommendation data are analyzed offline.

FIG. 6 is an illustration of a work flow diagram of an embodiment of the present invention wherein data are processed offline but queries are made on line.

FIG. 7 is an illustration of a work flow diagram of an embodiment of the present invention wherein data are collected and used within a single store.

FIG. 8 is an illustration of a work flow diagram of an embodiment of the present invention wherein a query is processed against several databases.

### DETAILED DESCRIPTION OF THE INVENTION

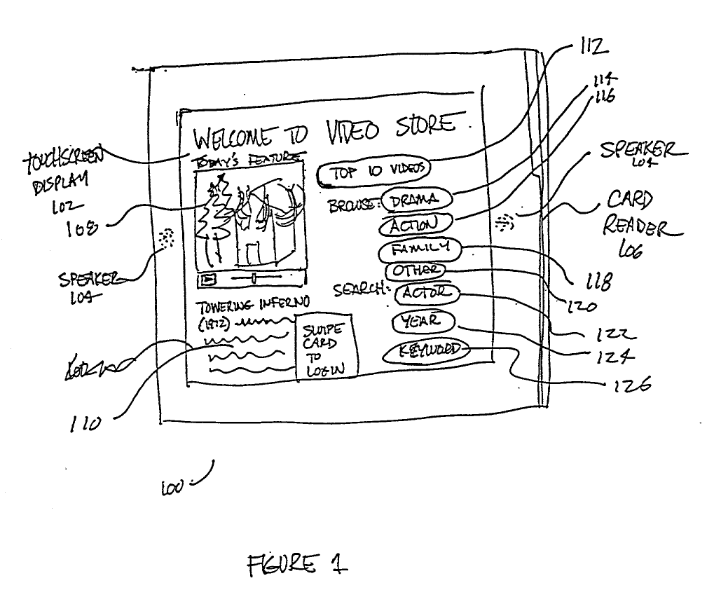

FIG. 1 illustrates an embodiment 100 of the present invention of a video store kiosk. The kiosk 100 comprises a touchscreen display 102, a pair of speakers 104, and a card reader 106. The display includes an area for previewing a movie that includes a motion picture 108 of a scene or preview of the movie, plus a description 110 of the movie. On the right hand side of the screen is a button 112 for a ‘top 10’ list of videos based on popularity. Other buttons 114, 116, 118, and 120 allow the user to browse various genres of movies. Search buttons 122, 124, and 126 allow the user to search for movies based on certain criteria.

The speakers 104 may play an audio track that corresponds with the video being shown in the area 108. When the kiosk 100 has not been used for a period of time, the motion picture 108 and the corresponding audio may be showing a movie that is being simultaneously shown on other television displays or kiosks throughout the store.

The kiosk 100 may be located with other kiosks at a central location in the store or be distributed at various locations in the store. When the kiosk 100 is located at various locations, for example in a section of the store dedicated to action movies, the previews and searches may be directed toward action movies. In other embodiments, the kiosks may be dispersed at various locations in the store but be identical.

The card reader 106 may be used by a user to swipe their identification card to access information particular to their account, such as referencing movies that the user had rented in the past, or indicating any affinity status or special offers that the particular user is eligible to receive. When a search is displayed and the user has swiped their card or otherwise identified themselves to the system, the search results may have the user's previously rented movies highlighted or indicated such that the user will be reminded that they have seen the movies before an may wish to enjoy the movie again. The user may be identified as an affinity user, for example having been a high frequency customer, and may be eligible for special offers or promotions. The special offers or promotions may be available only through the use of the kiosk and may be redeemed automatically at the time of checkout.

An example of a special offer may be to provide a special discount for a specific movie. The discount may only be made available to the identified user when that user has searched for the movie using the kiosk. If the special discount is a special discounted price, the price may be saved in the store's local database and retrieved when the customer checks out of the store.

The kiosk may be capable of allowing a user to search for a movie using several methods, such as by actor, director, keywords, or other factor. The results of a search may be a list of movies that fit the search criteria. From the list presented to the user, the user may be able to preview one or several movies. The user may be able to view a written description or summary of the movie, preview a motion picture trailer, view still pictures of the movie, view a review of the movie by a critic, or view any other descriptive data of the movie. The kiosk may be able to display general statistical data of the movie, including the gross receipts, number of academy awards, etc. The kiosk may display statistical data of the rental movie, including its popularity at the particular store or nationally. In some embodiments, a database of comparable movies may be queried to add a list of comparable movies to the search results. For example, a database of comparable movies may relate the movie Terminator to the movie Road Warrior, since the themes and genres are similar. A search for Terminator may result in the movie Road Warrior being displayed as a comparable movie suggestion.

The kiosk may reference a database of popular movies. The popular movie database may be based on historical data of the sales of a particular movie or of comparable movies to a particular movie. The database of popular movies may be kept in a local database within a store location, or may exist on a remote server and shared by many kiosks in many stores.

The kiosk may reference a database of inventory of the store. When a list of movies are presented to the user, those that are already checked out may be highlighted or indicated, and the user may have the ability to reserve the movie for a specific night. The kiosk may also display certain movies that have not been rented in a while but may be still be within the search criteria.

The central server may operate by processing data and sending updates to the local servers in each store on a periodic basis. In other embodiments, the central server may update the database in real time and also provide query results to each kiosk over the internet in real time.

The kiosk may have several different optional input devices, including a keyboard, microphone, stylus, and any type of personal identification device. A keyboard may be used for textual input or for selecting individual options. A microphone may be used for voice recognition applications, for indicating selections by voice or clapping, or other audible uses. A stylus or pointing device, such as a mouse or trackball, may also be used in lieu of or in addition to a touchscreen interface. Personal identification devices, other than the card reader 106, may be employed. Such devices may include fingerprint readers, retinal scanners, etc.

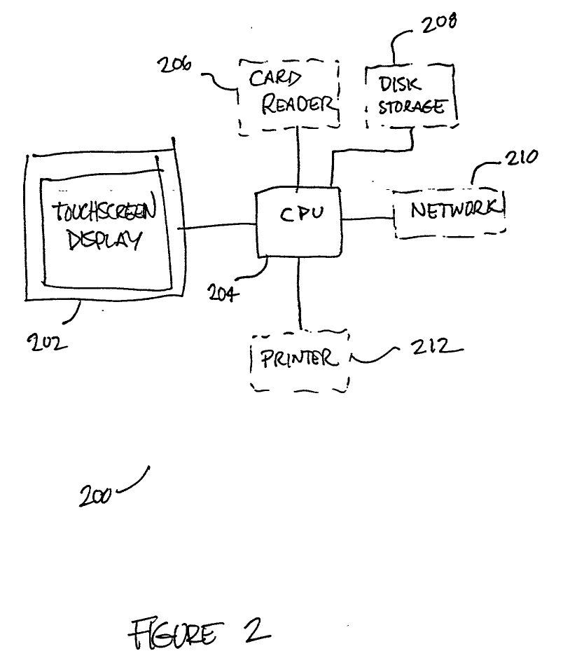

FIG. 2 illustrates an embodiment 200 of the present invention of the internal components of a kiosk. The touchscreen display 202 is connected to a central processing unit (CPU) 204. The CPU 204 may be connected to an optional card reader 206, an optional disk storage 208, an optional network 210, and an optional printer 212. Other accessories and peripherals may be attached to the kiosk 200 by those skilled in the arts without violating the spirit and intent of the present invention.

The embodiment 200 may be configured in a standalone configuration. In such a case, the kiosk 200 may not necessarily have a network connection 210. The standalone configuration may have a disk storage system 208 that can be updated by a CD-ROM or other replaceable media from time to time. Such a configuration may not connect to a central database to retrieve customer specific data and may be used solely for browsing and previewing videos.

The embodiment 200 may be configured to be connected to the internet via the network connection 210. In such a configuration, the embodiment 200 may operate a browser, such as an HTML browser, that communicates over the internet to a central server that receives HTML queries and sends HTML pages for display on the embodiment 200.

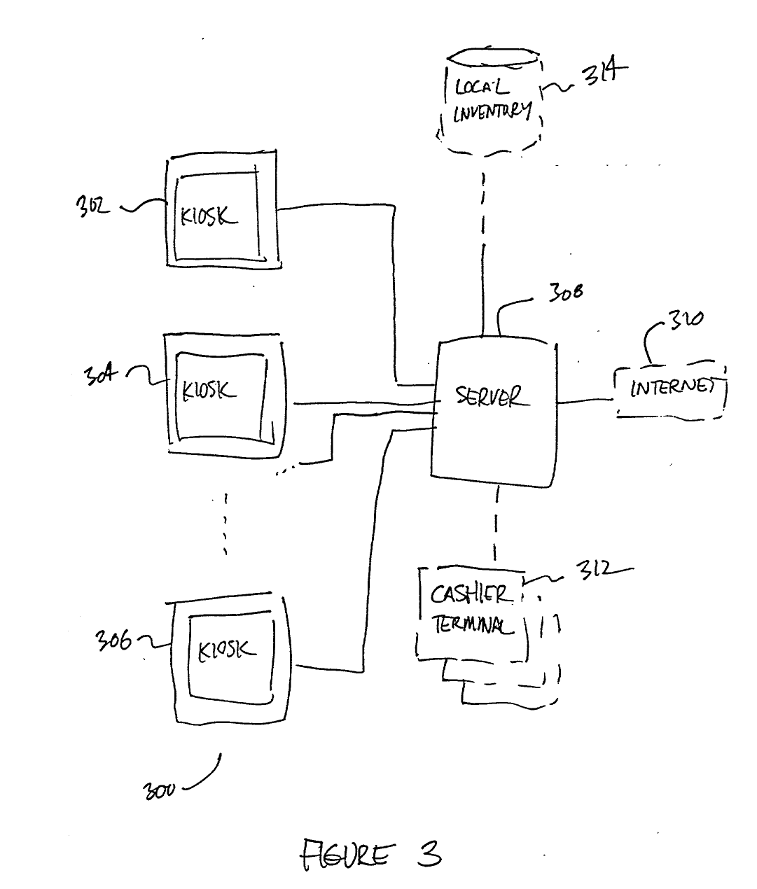

FIG. 3 illustrates an embodiment 300 of the present invention showing the network connections of several kiosks 302, 304, and 306 to a server 308 that is optionally connected to the internet 310. The embodiment 300 illustrates a typical installation inside a single store. Cashier terminals 312 may optionally be connected to the server 308, as well as a local inventory database 314.

The kiosks 302, 304, and 306 may be configured in a client/server configuration with the server 308. The client side may be a thin client or thick client, and those skilled in the art may configure the hardware architecture in several different ways while still maintaining within the spirit and intent of the present invention. The client may be running an HTML browser and the server may be receiving HTML queries and sending HTML pages for display on the client.

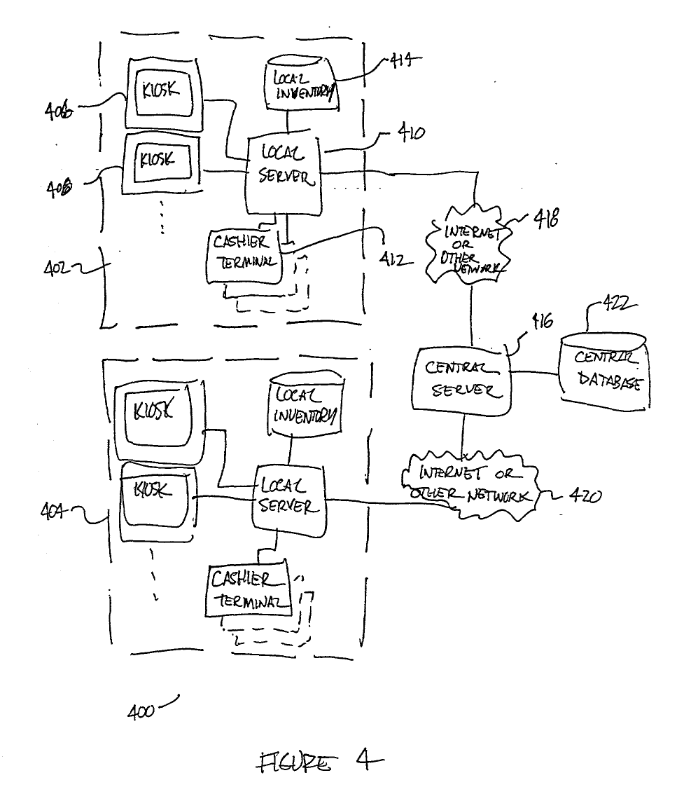

FIG. 4 illustrates an embodiment 400 of the present invention showing the network connections between two stores 402 and 404. Stores 402 contains kiosks 406 and 408, a local server 410, several cashier terminals 412, and a local inventory database 414. Store 404 is configured similarly to story 402. Store 402 is connected to a central server 416 through the internet or other network 418. Store 404 is similarly connected to the central server 416 through the internet or other network 420. The central server 416 is connected to a central database 422.

The stores 402 and 404 may be commonly owned stores or may be independent. In the case of commonly owned stores, the central server 416 may perform accounting and other functions in addition to the video preview and suggestion functions of the present invention. In the case of independent stores, the central server 416 may collect data from the independent stores 402 and 404 and send data back to stores 402 and 404 from time to time. The internet connections 418 and 420 may be connections for passing real time data or may be used intermittently.

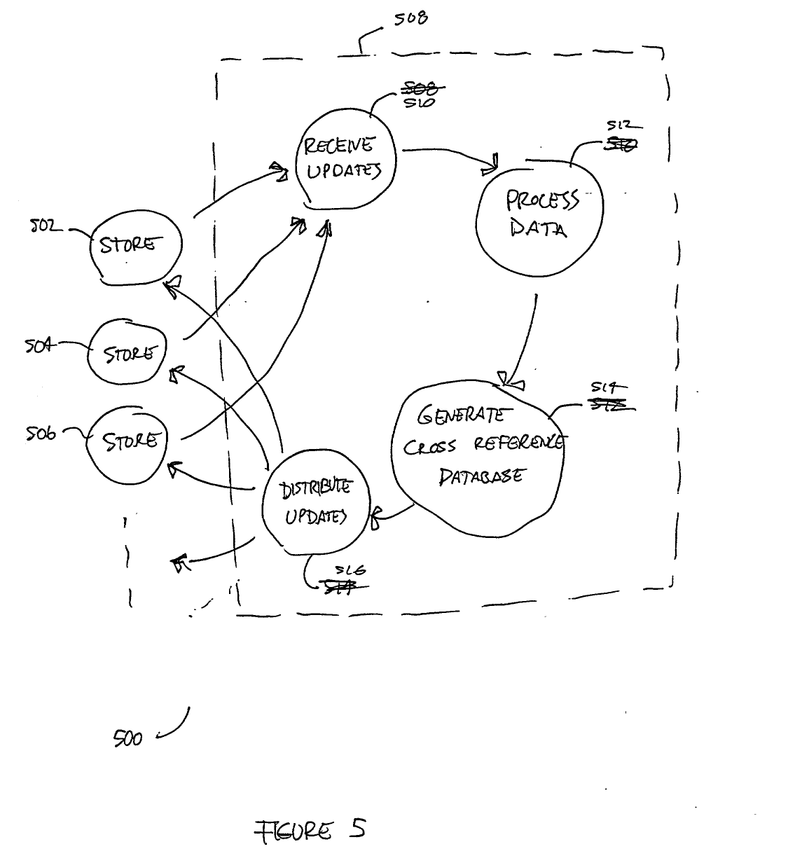

FIG. 5 illustrates a work flow diagram of an embodiment 500 of the present invention wherein recommendation data are analyzed offline. The stores 502, 504, and 506 generate data that can be used for building recommendation data. The offline processing, illustrated by box 508, may be performed by a remote server, such as the central server 416 illustrated in FIG. 4.

The offline processing 508 comprises receiving the data updates 510, processing the data 512, generating a cross reference database 514, and distributing the updates 516. The offline processing of the present embodiment 500 may be performed on a daily or weekly basis, for example. In some embodiments, the processing may be performed on certain days of the week and not on others.

The present embodiment 500 generates a cross reference database 514 that is used to generate a recommendation for a user of a kiosk. The various embodiments of the cross reference database 514 will be described herein after.

The embodiment 500 may be a system used by a retailer with several stores to collect and distribute recommendation data within the retailer's network of stores. In another use, the stores 502, 504, and 506 maybe independent stores who subscribe to a service that collects, processes, and distributes the data. Such a service may allow the independent video rental store to provide a recommendation and selection service of a large chain while still maintaining the independence of a small business.

The embodiment 500 has the advantage of generating a large amount of data by consolidating the results from several stores. The present embodiment 500 allows stores with lower sales volume, and thus a smaller amount of sales data, to have an effective recommendation system.

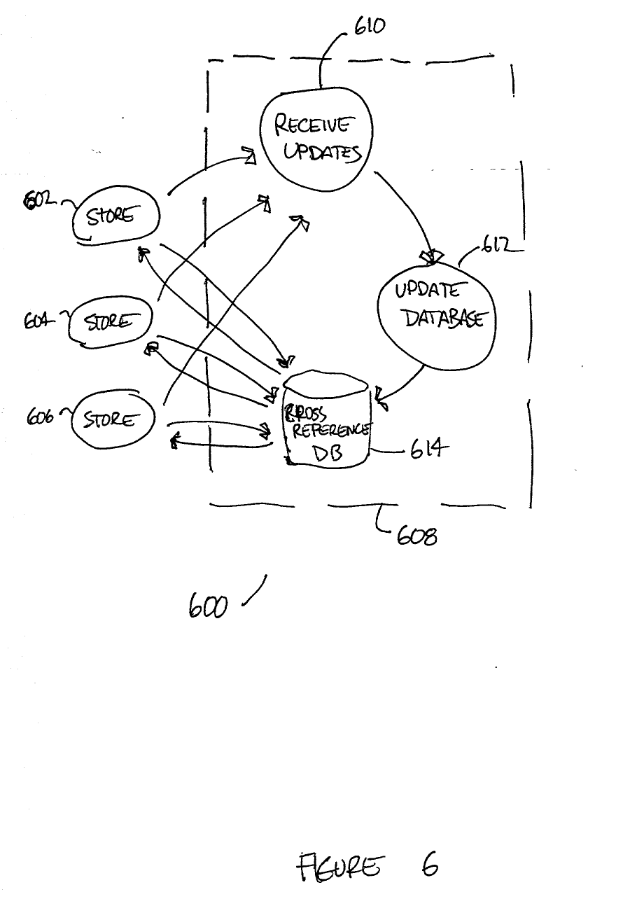

FIG. 6 illustrates a work flow diagram of an embodiment 600 of the present invention wherein data are processed offline but queries are made on line. The stores 602, 604, and 606 are connected to a central server 608, which may be the central server 416 of FIG. 4. Updates are received 610 and the database is updated 612. The cross reference database 614 is directly queried by the stores 602, 604, and 606 for each query. The reference database 614 may be hosted by a web server and the kiosks located in the various stores 602, 604, and 606 may be using a web browser or a modified web browser to query and display results from the reference database 614. In some embodiments, the user may be able to browse a movie's website through the internet.

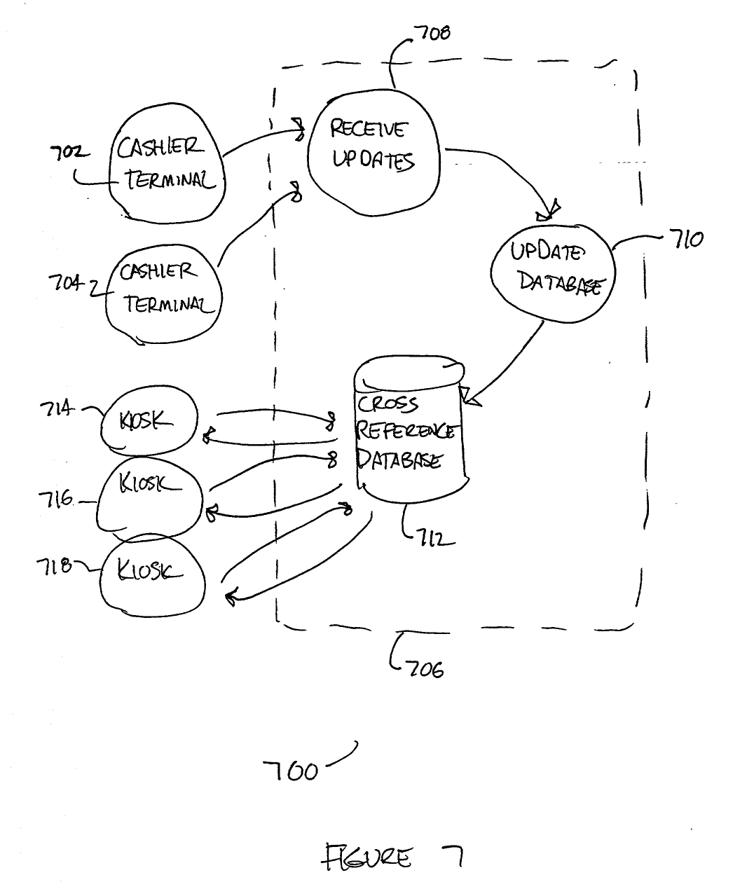

FIG. 7 illustrates a work flow diagram of an embodiment 700 of the present invention wherein data are collected and used within a single store. The cashier terminals 702 and 704 communicate with the local server 706. The local server 706 is similar to the server 308 of FIG. 3. Within the server 706, the data are received 708, the database is updated 710 into the cross reference database 712. The kiosks 714, 716, and 718 query the database 712 and display the results of the queries.

The embodiment 700 represents a system that may be located completely within a single store. The cross reference database 712 may be updated periodically in a batch mode, such as every night, or the database 712 may be updated with each transaction of the cashier terminal 702 and 704.

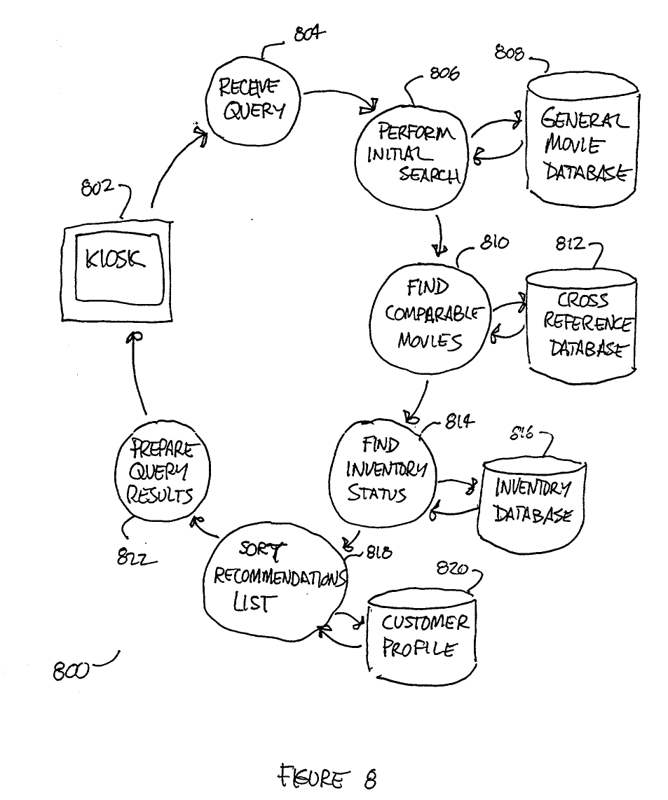

FIG. 8 illustrates a work flow diagram of an embodiment 800 of the present invention wherein a recommendation list is processed. A consumer uses a kiosk 802 to generate a query that is received 804. An initial search is performed 806 against a generate database 808. A second search is performed to find comparable movies 810 against a cross reference database 812. An inventory search 814 is performed against the inventory database 816. The recommendations list is sorted 818, using the customer profile 820. The query results are prepared 822 and sent to the kiosk 802 for display.

The initial search 806 is performed against a general movie database 808. For example, the search may be for movies with the actor Sean Connery. The general movie database 808 may contain references to all of Sean Connery's movies. The initial search 806 may return with a list of movies and also include a ranking index. In the example, those movies in which Sean Connery was the leading actor may be ranked higher than a movie where Sean Connery was a supporting actor.

The list of movies generated with the initial search 806 are ran against the cross reference database 812 to find comparable movies 810. The cross reference database 812 may be a predetermined list of movies that related to other movies, such as those with common keywords, classified by similar genre, have related actors or directors, or any other predetermined cross reference. In addition, the cross reference database 812 may comprise consumer purchasing information for similar movies, such as popularity data compiled over a certain group of stores. The comparable movie search 810 may add many more movie titles to the results of the query. The comparable movie search 810 may include a ranking of popularity or an indicia of the closeness or applicability of the cross referenced title to the initial search. A ranking index for each movie may be compiled from the search 810.

The inventory status 814 of the list of movies is generated against the inventory database 816. Each movie in the query results so far may be compared to see if the movie is within the store's inventory and whether or not the movie is currently checked out. A ranking index may be compiled from the inventory status search 814. For example, slow selling movies may be ranked higher than those for which no inventory is available or those movies that have little inventory available. In some instances, some movies may be specially flagged for promotion based on their inventory status. For example, the results of the inventory status 814 may uncover a movie that has not been rented in a certain period of time. The sort routine may flag that particular movie for an instant promotion. Such a promotion may involve a special discount or a premium such as a bag of popcorn. In some embodiments, the particular movie that is less popular may be combined with a more popular movie as a package set.

The recommendations list may be sorted 818 using the customer profile 820 database. The list of all the results of the initial search 806, plus the comparable movies 808 and the inventory status 814 of all the results, are sorted. The customer profile 820 may include a list of the previously viewed movies for the particular customer. In addition, the customer's preferences, either explicitly or implicitly derived, may be further used to rank the list of recommended movies.

The recommendation list may be sorted by multiplying the ranking indicia of the all the search results and sorting based on the resultant ranking index. The list may have movies previously rented by the customer highlighted or otherwise indicated. In some embodiments, the previously rented movies may be excluded from the recommended list.

The retailer may be able to instantly and automatically identify and promote a slow selling item to someone who has shown at least some interest in the item or a related item. The ability to instantly identify and promote slow selling items may be a large revenue generator for the retailer, allowing the retailer to more efficiently use the existing inventory. The movie recommendation list may be further refined to link two or more movies together as a recommended pair or set of movies to purchase together. For example, the list of Sean Connery movies may have a popular movie bundled with an older, related movie that does not get rented very often. In this manner, the retailer may increase the overall sales by offering an extra movie at a reduced price.

The retailer may offer an instant promotion of a slow selling item such as giving an instant 50% discount for the purchase of the slow selling item. Such a decision may be based on the inventory history of the item, but may also include the customer's purchase history.

A special promotion may be made available to the particular customer based on their past history of movie rentals. For example, for a customer who has consistently purchased only one movie at a time, a bundled pair of movies might be presented at a discount. In another example, a customer who is a consistent and regular customer may be offered two premium movies for a special discount price.

The promotional offer may be such that it is available only through the use of the kiosk. Since the customer may be identified by the swiping of their card through the card reader, a promotion or discount may be made available only to that customer at that time and recalled when the customer checks out of the store.

When a query is sorted, those movies that are not in the current store's inventory of titles may be removed from the list. The removed titles may be stored in a separate database with their ranking indicia for further analysis by the retailer. The removed titles may be sorted to indicate titles that may be considered for addition to the store's inventory. Movies that receive multiple ‘hits’ during the recommendation search may be consisted for additions to the store inventory.

The present embodiment 800 may be applied to the on line purchasing of products. In such embodiments, the inventory of an item may be a factor in determining the price of a product. For example, if the inventory search reveals that the product is very popular, a premium price might be offered. For items that are overstocked, the price may be reduced. Such offers may be only valid for a certain time, putting some pressure or incentive for the consumer to finish the transaction immediately. For example, if the price was reduced on a slow selling item, the reduced price may only be available for the next thirty minutes, after which the price may return to the original price.

The kiosk may be located at various locations throughout a video rental store and provide a computerized assistance in previewing and selecting movies for rental. The kiosk may be located in the store entranceway, at the point of sale amongst the video titles on a shelf, at or near the check out area, or other places within the store. The kiosk may be used by simply performing searches, browsing movie titles, researching various information about the movies, and checking the inventory status of the movies. The kiosk may allow a user to log in and access lists of previously rented movies. The user may log in by entering their name and password, the user may swipe their personal card issued by the rental store, or by any other method of self identification. By logging in, the search results may show movies that are preferential to the user as well as offering special promotions or discounts to that specific user.

The kiosks may be connected to a local server within a store. The local server may contain the movie database that contains the movie previews, statistical data, and all other data used to perform searches and display results. In some embodiments, the queries may be made to an on line server that resides outside of the store, and the on line server may perform a similar function for a multitude of kiosks in a multitude of stores. The central sever may be a service performed for several independent movie rental stores or may only be available to the stores within a certain ownership or corporation.

The server that provides the query results may accept data from a store or stores to compile a database of popular movies. The database may be compiled at certain intervals, such as once a day or once a week, or the database may be updated in real time with real time queries.

The queries or searches performed by a consumer at a kiosk may include the searching of an inventory database. The inventory database may be used to rank slower moving items at a higher place in a list of recommendations for a consumer. Based on the query results of the inventory database, special promotions, such as bundled packages or special discounts, may be offered. In addition, the queries of the inventory database wherein a recommended movie or item is not found in the database may be stored as recommendations for the retailer to increase the store inventory with certain titles.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A system for assisting a purchaser in the selection of a product with inventory sensitive recommendations on a computerized kiosk in a retail environment comprising:
a kiosk comprising at least one input device and at least one display device; and
a server computer connected to said kiosk capable of receiving input on said kiosk by said purchaser, creating a first query for a recommendation database, said first query comprising said input, querying said recommendation database with said first query to generate a first list of recommendations, creating a second query for an inventory database, said second query comprising said first list of recommendations, said inventory database being a database of inventory of products available in said retail environment, querying said inventory database with said second query to generate inventory data, said inventory data comprising the availability of said product in the inventory of said retail environment and further comprising sales history, generating a second list of recommended products using said first list and said inventory data; and presenting said second list to said purchaser on said kiosk.

2. The system of claim 1 wherein said input from said purchaser comprises identifying said purchaser.

3. The system of claim 2 wherein said server is further capable of retrieving a history of the purchases by said purchaser to generate said first query.

4. The system of claim 2 wherein said input from said purchaser further comprises input from a card reader.

5. The system of claim 1 wherein generating said second list further comprises:
identifying at least one product on said first list as a promotional product using said inventory data and presenting said promotional product to said purchaser on a display of said kiosk, said presentation being different from said second list.

6. The system of claim 1 wherein said recommendation database is located remotely from said retail environment and is queried by a plurality of said kiosks located in a plurality of retail environments.

7. The system of claim 6 wherein said recommendation database comprises data for products that are not in inventory at said retail environment.
